(19) United States
(12) Patent Application Publication
(10) Pub. No.: US 2022/0217629 A1
(43) Pub. Date: Jul. 7, 2022

(54) POWER SAVING

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 17/610,794

(22) PCT Filed: May 14, 2019
(86) PCT No.: PCT/CN2019/086906

§ 371 Date: Nov. 12, 2021

(51) Int. Cl. H04W 52/02; H04W 72/12

(52) U.S. Cl. CPC H04W 52/0216; H04W 52/0229; H04W 72/1289

(57) ABSTRACT

Embodiments of the present disclosure relate to methods, devices and computer readable media for power saving. A method of communication comprises receiving, at a terminal device in a first scheduling mode, first control information from a network device; determining whether the first control information includes an indication to switch from the first scheduling mode to a second scheduling mode; and in response to the first control information including the indication, switching from the first scheduling mode to the second scheduling mode. Embodiments of the present disclosure enable dynamic switching between different scheduling modes.

### TECHNICAL FIELD

Embodiments of the present disclosure generally relate to the field of telecommunication, and in particular, to methods, devices and computer storage media for power saving.

### BACKGROUND

A terminal device (such as, UE) can be configured with one or more scheduling offset values. A scheduling offset value indicates a slot offset between reception of scheduling information and a data communication scheduled by the scheduling information. Typically, the scheduling mode of the UE depends on the minimum one of the one or more scheduling offset values. For example, if the minimum one of the one or more scheduling offset values exceeds zero, it means that the reception of the scheduling information and the data communication occur in different slots. Therefore, once receiving the scheduling information, the UE can turn off its radio function for one or more slots and then turn on its radio function to perform the data communication scheduled by the scheduling information, so as to reduce its power consumption. However, if the minimum one of the one or more scheduling offset values is zero, the reception of the scheduling information and the data communication may occur in a same slot. Therefore, the UE cannot turn off its radio function when receiving the scheduling information. When the UE is in the scheduling mode for power saving, in some cases, it may need to be switched to the other scheduling mode for quick scheduling.

On the other hand, a network device (such as, gNB) can indicate a downlink measurement RS (such as, an aperiodic CSI-RS (AP-CSI-RS)) for a terminal device (such as, UE) to determine uplink candidate pre-coders for an aperiodic SRS (AP-SRS) via Downlink Control Information (DCI). That is, the AP-SRS can be associated with the AP-CSI-RS. The network device can delay transmission of the AP-CSI-RS by several slots than the transmission of the DCI containing a trigger of the AP-SRS, so as to reduce power consumption. However, this may decrease a time interval between reception of the AP-CSI-RS and transmission of the AP-SRS at the UE. If the interval is below a threshold (such as, 42 OFDM symbols), the uplink pre-coder for the AP-SRS will not be updated.

### SUMMARY

In general, example embodiments of the present disclosure provide methods, devices and computer storage media for power saving.

In a first aspect, there is provided a method of communication. The method comprises: receiving, at a terminal device in a first scheduling mode, first control information from a network device; determining whether the first control information includes an indication to switch from the first scheduling mode to a second scheduling mode; and in response to the first control information including the indication, switching from the first scheduling mode to the second scheduling mode.

In a second aspect, there is provided a method of communication. The method comprises: generating, at a network device in a first scheduling mode, first control information including an indication to switch from the first scheduling mode to a second scheduling mode; transmitting the first control information to a terminal device; and switching from the first scheduling mode to the second scheduling mode.

In a third aspect, there is provided a method of communication. The method comprises: transmitting, from a first device, a request for a Sounding Reference Signal (SRS) to a second device in a first slot, the SRS being associated with a Channel State Information-Reference Signal (CSI-RS); in response to the first device being configured with a first slot offset between transmission of the request and transmission of the CSI-RS, transmitting the CSI-RS to the second device in a second slot later than the first slot by the first slot offset; in response to the first device being configured with a second slot offset between transmission of the request and reception of the SRS, determining a third slot for receiving the SRS from the second device based on the first and second slot offsets; and receiving the SRS from the second device in the third slot.

In a fourth aspect, there is provided a method of communication. The method comprises: receiving, from a first device, a request for a Sounding Reference Signal (SRS) at a second device in a first slot, the SRS being associated with a Channel State Information-Reference Signal (CSI-RS); in response to the second device being configured with a first slot offset between reception of the request and reception of the CSI-RS, receiving the CSI-RS from the first device in a second slot later than the first slot by the first slot offset; in response to the second device being configured with a second slot offset between reception of the request and transmission of the SRS, determining a third slot for transmitting the SRS to the first device based on the first and second slot offsets; and transmitting the SRS to the first device in the third slot.

In a fifth aspect, there is provided a device of communication. The receiving device comprises a processor and a memory coupled to the processor. The memory stores instructions that when executed by the processor, cause the receiving device to perform the method according to the first aspect of the present disclosure.

In a sixth aspect, there is provided a device of communication. The transmitting device comprises a processor and a memory coupled to the processor. The memory stores instructions that when executed by the processor, cause the transmitting device to perform the method according to the second aspect of the present disclosure.

In a seventh aspect, there is provided a device of communication. The receiving device comprises a processor and a memory coupled to the processor. The memory stores instructions that when executed by the processor, cause the receiving device to perform the method according to the third aspect of the present disclosure.

In an eighth aspect, there is provided a device of communication. The transmitting device comprises a processor and a memory coupled to the processor. The memory stores instructions that when executed by the processor, cause the transmitting device to perform the method according to the fourth aspect of the present disclosure.

In a ninth aspect, there is provided a computer readable medium having instructions stored thereon. The instructions, when executed on at least one processor, cause the at least one processor to perform the method according to the first aspect of the present disclosure.

In a tenth aspect, there is provided a computer readable medium having instructions stored thereon. The instructions, when executed on at least one processor, cause the at least one processor to perform the method according to the second aspect of the present disclosure.

In an eleventh aspect, there is provided a computer readable medium having instructions stored thereon. The instructions, when executed on at least one processor, cause the at least one processor to perform the method according to the third aspect of the present disclosure.

In a twelfth aspect, there is provided a computer readable medium having instructions stored thereon. The instructions, when executed on at least one processor, cause the at least one processor to perform the method according to the fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates an example signaling chart illustrating a process for switching between different scheduling modes in accordance with some embodiments of the present disclosure;

FIG. 3 illustrates an example method in accordance with some embodiments of the present disclosure;

FIG. 4 illustrates an example method in accordance with some embodiments of the present disclosure;

FIGS. 5A and 5B illustrate example diagrams of AP-CSI-RS and AP-SRS transmission in traditional solutions.

FIG. 6 illustrates an example signaling chart illustrating a process for AP-CSI-RS and AP-SRS transmission in accordance with some embodiments of the present disclosure;

FIGS. 7A and 7B illustrate example diagrams of AP-CSI-RS and AP-SRS transmission in accordance with some embodiments of the present disclosure;

FIG. 8 illustrates an example method in accordance with some embodiments of the present disclosure;

FIG. 9 illustrates an example method in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

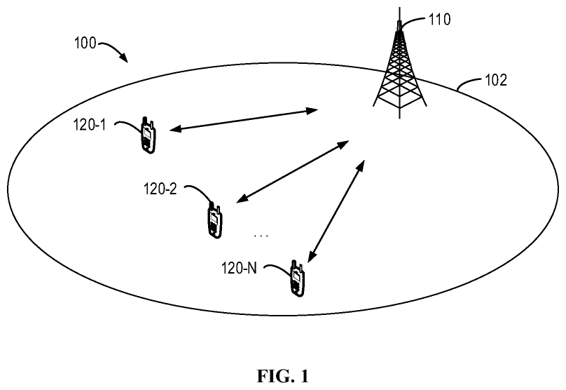

FIG. 1 shows an example communication network 100 in which implementations of the present disclosure can be implemented. The communication network 100 includes a network device 110 and terminal devices 120-1, 120-2 . . . and 120-N (where N is a natural number), which can be collectively referred to as “terminal devices” 120 or individually referred to as “terminal device” 120. The network 100 can provide one or more cells 102 to serve the terminal device 120. It is to be understood that the number of network devices, terminal devices and/or cells is given for the purpose of illustration without suggesting any limitations to the present disclosure. The communication network 100 may include any suitable number of network devices, terminal devices and/or cells adapted for implementing implementations of the present disclosure.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In the communication network 100 as shown in FIG. 1, the network device 110 can communicate data and control information to the terminal device 120 and the terminal device 120 can also communicate data and control information to the network device 110. A link from the network device 110 to the terminal device 120 is referred to as a downlink (DL), while a link from the terminal device 120 to the network device 110 is referred to as an uplink (UL).

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

As described above, the terminal device 120 can be configured with one or more scheduling offset values. A scheduling offset value may indicate a slot offset between reception of scheduling information (such as, an UL grant for UL data transmission, a DL grant for DL data transmission or a trigger of CSI-RS transmission received in DCI) and a data communication (such as, UL data transmission, DL data transmission or CSI-RS transmission) scheduled by the scheduling information. Typically, the scheduling mode of the terminal device 120 may depend on the minimum one of the one or more scheduling offset values. For example, if the minimum one of the one or more scheduling offset values exceeds zero, it means that the reception of the scheduling information and the data communication are certainly in different slots. Therefore, once receiving the scheduling information, the terminal device 120 can turn off its radio function for one or more slots and then turn on its radio function to perform the data communication scheduled by the scheduling information, so as to reduce its power consumption. However, if the minimum one of the one or more scheduling offset values is zero, the reception of the scheduling information and the data communication can occur in a same slot, so as to achieve quick scheduling. Therefore, the terminal device 120 cannot turn off its radio function when receiving the scheduling information, since the data communication may occur in the same slot soon. When the terminal device 120 is in the scheduling mode for power saving (that is, the minimum one of the one or more scheduling offset exceeds zero), in some cases, it may need to be switched to the other scheduling mode for quick scheduling.

Example embodiments of the present disclosure provide a solution for switching between different scheduling modes. This solution enables the network device 110 and the terminal device 120 to dynamically switch between the scheduling mode for power saving and the scheduling mode for quick scheduling.

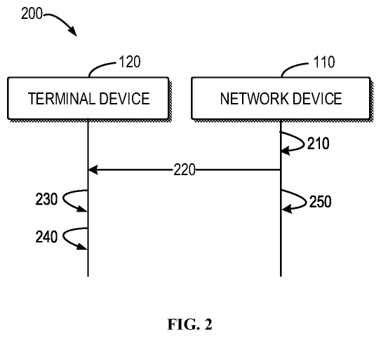

FIG. 2 illustrates an example signaling chart illustrating a process 200 for switching between different scheduling modes in accordance with some embodiments of the present disclosure. For the purpose of discussion, the process 200 will be described with reference to FIG. 1. The process 200 may involve the network device 110 and the terminal device 120 as shown in FIG. 1. It is to be understood that the process 200 may include additional acts not shown and/or may omit some acts as shown, and the scope of the present disclosure is not limited in this regard.

In FIG. 2, it is assumed that the network device 110 and the terminal device 120 are initially in the scheduling mode for power saving (also referred to as “first scheduling mode”). In some cases, the network device 110 may determine to switch from the first scheduling mode for power saving to the other scheduling mode (also referred to as “second scheduling mode”) so as to achieve quick scheduling. It is to be understood that this is merely for the purpose of illustration, without suggesting any limitation to the present disclosure. Embodiments of the present disclosure are also applicable to switching from the second scheduling mode to the first scheduling mode.

In some embodiments, as shown in FIG. 2, the network device 110 may generate first control information (such as, DCI) including an indication to switch from the first scheduling mode to the second scheduling mode. The network device 110 may transmit 220 the first control information to the terminal device 120. The terminal device 120 may determine 230 whether the first control information includes the indication to switch from the first scheduling mode to the second scheduling mode. In response to the first control information including the indication, the terminal device 120 may switch 240 from the first scheduling mode to the second scheduling mode. Likewise, in response to the first control information including the indicating being transmitted to the terminal device 120, the network device 110 may also switch 250 from the first scheduling mode to the second scheduling mode.

In some embodiments, the network device 110 in the first scheduling mode may be configured with one or more scheduling offset values for the first scheduling mode. For example, the minimum one of the one or more scheduling offset values may be greater than zero, which means that transmission of scheduling information (such as, an UL grant for UL data transmission, a DL grant for DL data transmission or a trigger of CSI-RS transmission received in DCI) and a data communication (such as, Physical Uplink Shared Channel (PUSCH) transmission, Physical Downlink Shared Channel (PDSCH) transmission or CSI-RS transmission) scheduled by the scheduling information occur in different slots. In some embodiments, the network device 110 may determine a scheduling offset value that is below the minimum one of the first group of scheduling offset values, and include the determined scheduling offset value in the first control information as the indication.

In some embodiments, the terminal device 120 in the first scheduling mode may also be configured with the one or more scheduling offset values, the minimum one of which may exceed zero. In some embodiments, if the first control information received by the terminal device 120 includes a scheduling offset value that is below the minimum one of the one or more scheduling offset values for the first scheduling mode, the terminal device 120 may determine that the first control information includes the indication for switching the scheduling mode. In some embodiments, if the first control information received by the terminal device 120 includes a scheduling offset value that is equal to or greater than the minimum one of the one or more scheduling offset values for the first scheduling mode, the terminal device 120 may determine that the first control information does not include the indication for switching the scheduling mode.

Alternatively, in some embodiments, the network device 110 may include an indication to switch from the first scheduling mode to the second scheduling mode in a field (for example, a 1-bit field) of the first control information. For example, if a value of the field is A, it may indicate that the scheduling mode is to be switched from the current scheduling mode (such as, the first scheduling mode) to the other scheduling mode (such as, the second scheduling mode). However, if the value of the field is B, it may indicate that the scheduling mode is not to be switched.

In some embodiments, if the first control information received by the terminal device 120 includes the field with the value A, the terminal device 120 may determine that the first control information includes the indication for switching the scheduling mode. In some embodiments, if the first control information received by the terminal device 120 includes the field with the value B, the terminal device 120 may determine that the first control information does not include the indication for switching the scheduling mode.

In some embodiments, in response to the indication for switching the scheduling mode being received by the terminal device 120, the terminal device 120 may switch from the first scheduling mode to the second scheduling mode by disabling the minimum one of the one or more scheduling offset values for the first scheduling mode. That is, the minimum one of the one or more scheduling offset values configured for scheduling PDSCH, PUSCH and/or CSI-RS transmission may not be used in the following scheduling. In some embodiments, the disabling of the minimum one of the one or more scheduling offset values may last for a period of time. For example, the period of time may be pre-defined, pre-configured or configured to the terminal device 120. In some embodiments, in response to the terminal device 120 having switched from the first scheduling mode to the second scheduling mode for the period of time, the terminal device 120 may switch from the second scheduling mode back to the first scheduling mode. That is, the minimum one of the one or more scheduling offset values configured for scheduling PDSCH, PUSCH and/or CSI-RS transmission may be resumed and used in the following scheduling.

Similarly, in some embodiments, in response to the indication for switching the scheduling mode being transmitted to the terminal device 120, the network device 110 may switch from the first scheduling mode to the second scheduling mode by disabling the minimum one of the one or more scheduling offset values for the first scheduling mode. That is, the minimum one of the one or more scheduling offset values configured for scheduling PDSCH, PUSCH and/or CSI-RS transmission may not be used in the following scheduling. In some embodiments, the disabling of the minimum one of the one or more scheduling offset values may last for a period of time. For example, the period of time may be pre-defined or pre-configured at the network device 110. In some embodiments, the network device 110 may configure the period of time to the terminal device 120. In some embodiments, in response to the network device 110 having switched from the first scheduling mode to the second scheduling mode for the period of time, the network device 110 may switch from the second scheduling mode back to the first scheduling mode. That is, the minimum one of the one or more scheduling offset values configured for scheduling PDSCH, PUSCH and/or CSI-RS transmission may be resumed and used in the following scheduling.

In some embodiments, the first control information may include scheduling information for scheduling a data communication. For example, the scheduling information may include an UL grant for PUSCH transmission, a DL grant for PDSCH transmission or a trigger for AP-CSI-RS transmission. In some embodiments, the scheduling information in the first control information may be ignored by the network device 110 and/or the terminal device 120. That is, the network device 110 and/or the terminal device 120 may not perform the data communication scheduling by the scheduling information in the first control information.

Alternatively, in some embodiments, the first control information may include scheduling information for scheduling a data communication. For example, the scheduling information may include an UL grant for PUSCH transmission, a DL grant for PDSCH transmission or a trigger for AP-CSI-RS transmission. In some embodiments, in response to the first control information include scheduling information for scheduling a data communication, the network device 110 and/or the terminal device 120 may determine a scheduling offset value from the one or more scheduling offset values configured for the first scheduling mode, and perform the data communication based on the determined scheduling offset value. That is, in this case, the minimum one of the one or more scheduling offset values configured for the first scheduling mode is applicable to this scheduling. The network device 110 may switch to the second scheduling mode (in which the minimum scheduling offset value is zero) on a next occasion for transmitting second control information. Likewise, the terminal device 120 may switch to the second scheduling mode (in which the minimum scheduling offset value is zero) on a next occasion for receiving the second control information.

In some embodiments, a first group of scheduling offset values may be configured for the first scheduling mode and the minimum one of the first group of scheduling offset values may exceed zero. For example, the first group of scheduling offset values may be configured to both the network device 110 and the terminal device 120. Additionally, in some embodiments, a second group of scheduling offset values may be configured for the second scheduling mode and the minimum one of the second group of scheduling offset values may be zero. For example, the second group of scheduling offset values may also be configured to both the network device 110 and the terminal device 120. In some embodiments, one of the first group of scheduling offset values may be associated with a corresponding one of the second group of scheduling offset values. Table 1 illustrates such embodiments in the following.

TABLE 1
Two groups of scheduling offset values
for different scheduling modes

| GROUP 0 | GROUP 1 |
|---|---|
| A0 | A1 |
| B0 | B1 |
| C0 | C1 |
| D0 | D1 |

As shown in Table 1, GROUP 0 may include four scheduling offset values A0, B0, C0 and D0, which are configured for the second scheduling mode (that is, the scheduling mode for quick scheduling). In some embodiments, for example, the minimum one of the four scheduling offset values A0, B0, C0 and D0 is zero. As shown in Table 1, GROUP 1 may include four scheduling offset values A1, B1, C1 and D1, which are configured for the first scheduling mode (that is, the scheduling mode for power saving). In some embodiments, for example, the minimum one of the four scheduling offset values A1, B1, C1 and D1 is greater than zero. In some embodiments, one value in GROUP 0 may be associated with a correspond one in GROUP 1. For example, A0 may be associated with A1; B0 may be associated with B1; C0 may be associated with C1; and D0 may be associated with D1.

In some embodiments, the network device 110 in the first scheduling mode may determine to switch the scheduling mode. The network device 110 may select a scheduling offset value from GROUP 0 for the second scheduling mode, and include the selected scheduling offset value in the first control information as the indication for switching the scheduling mode.

In some embodiments, if the first control information received by the terminal device 120 in the first scheduling mode includes a scheduling offset value from GROUP 0, the terminal device 120 may determine that the first control information includes the indication for switching the scheduling mode. Alternatively, if the first control information includes a scheduling offset value from GROUP 1, the terminal device 120 may determine that the first control information does not include the indication for switching the scheduling mode. That is, the terminal device 120 may stay in the first scheduling mode for power saving in the following scheduling.

In some embodiments, in response to the first control information including a scheduling offset value (such as, A0) from GROUP 0 being received by the terminal device 120 in the first scheduling mode, the terminal device 120 may switch from the first scheduling mode to the second scheduling mode. In some embodiments, the terminal device 120 may switch from the first scheduling mode to the second scheduling mode by disabling GROUP 1 for the first scheduling mode. That is, the scheduling offset values from GROUP 1 may not be used in the following scheduling. In some embodiments, the disabling of GROUP 1 may last for a period of time. For example, the period of time may be pre-defined, pre-configured or configured to the terminal device 120. In some embodiments, in response to the terminal device 120 having switched from the first scheduling mode to the second scheduling mode for the period of time, the terminal device 120 may switch from the second scheduling mode back to the first scheduling mode. That is, the scheduling offset values from GROUP 1 may be resumed and used in the following scheduling.

Similarly, in some embodiments, in response to the first control information including a scheduling offset value (such as, A0) from GROUP 0 being transmitted to the terminal device 120 in the first scheduling mode, the network device 110 may switch from the first scheduling mode to the second scheduling mode. In some embodiments, the network device 110 may switch from the first scheduling mode to the second scheduling mode by disabling GROUP 1 for the first scheduling mode. That is, the scheduling offset values from GROUP 1 may not be used in the following scheduling. In some embodiments, the disabling of GROUP 1 may last for a period of time. For example, the period of time may be pre-defined or pre-configured at the network device 110. In some embodiments, the network device 110 may configure the period of time to the terminal device 120. In some embodiments, in response to the network device 110 having switched from the first scheduling mode to the second scheduling mode for the period of time, the network device 110 may switch from the second scheduling mode back to the first scheduling mode. That is, the scheduling offset values from GROUP 1 may be resumed and used in the following scheduling.

In some embodiments, the first control information may include scheduling information for scheduling a data communication. For example, the scheduling information may include an UL grant for PUSCH transmission, a DL grant for PDSCH transmission or a trigger for AP-CSI-RS transmission. In some embodiments, the scheduling information in the first control information may be ignored by the network device 110 and/or the terminal device 120. That is, the network device 110 and/or the terminal device 120 may not perform the data communication scheduling by the scheduling information in the first control information.

Alternatively, in some embodiments, the first control information may include scheduling information for scheduling a data communication. For example, the scheduling information may include an UL grant for PUSCH transmission, a DL grant for PDSCH transmission or a trigger for AP-CSI-RS transmission. In some embodiments, in response to the first control information include scheduling information for scheduling a data communication, the network device 110 and/or the terminal device 120 may determine a scheduling offset value from GROUP 1 configured for the first scheduling mode, and perform the following data communication based on the determined scheduling offset value. For example, in response to the first control information including a scheduling offset value (such as, A0) from GROUP 0, the network device 110 and/or the terminal device 120 may determine, from GROUP 1, a corresponding scheduling offset value (that is, A1) that is associated with the scheduling offset value (that is, A0) from GROUP 0, and perform the following data communication based on the corresponding scheduling offset value (that is, A1) from GROUP 1.

In some embodiments, the terminal device 120 may be configured with a set of scheduling offset values. For example, the set of scheduling offset values may be represented as {F₁, F₂, . . . , F_{N}}, where N is an integer and N>=1, and where Fᵢ indicates a slot offset between scheduling information and a data communication scheduled by the scheduling information and Fᵢ is a non-negative integer. In some embodiments, the scheduling information may include any of the following: an UL grant for UL data transmission, a DL grant for DL data transmission or a trigger of CSI-RS transmission received in DCI. The data communication scheduled by the scheduling information may include any of the following: PUSCH transmission, PDSCH) transmission or CSI-RS transmission. In some embodiments, the terminal device 120 may be configured with a minimum valid scheduling offset value, for example, Kₘ. For example, the minimum valid scheduling offset value may be configured via RRC signaling or via Media Access Control (MAC) Control Element (CE). In some embodiments, Kₘ may be a non-negative integer. In some other embodiments, Kₘ may be an integer and Kₘ>0. In some embodiments, the terminal device 120 may only expect to be indicated with a value Fᵢ (where Fᵢ>=Kₘ) which is included in the set of scheduling offset values. In some embodiments, the terminal device 120 may be indicated with a value Fᵢ (where Fᵢ<Kₘ) and the terminal device may assume that the minimum valid scheduling offset value is changed to be Fᵢ. In some embodiments, the terminal device 120 may be indicated with a value Fᵢ (where Fᵢ<Kₘ) and the terminal device 120 may assume that the minimum valid scheduling offset is changed to be 0. For example, the scheduling mode may be switched to the second scheduling mode as described above (that is, the scheduling mode for quick scheduling other than power saving). In some embodiments, the terminal device 120 may be indicated with one or more values Fᵢ (where Fᵢ<Kₘ) in one PDCCH, and the terminal device 120 may ignore the scheduling information in this PDCCH. In some embodiments, the terminal device 120 may be indicated with one or more values one or more values Fᵢ (where Fᵢ<Kₘ) in one PDCCH, and the terminal device 120 may ignore the scheduled PDSCH, PUSCH or CSI-RS (such as, AP-CSI-RS). In some embodiments, the terminal device 120 may be indicated with one or more values Fᵢ (where Fᵢ<Kₘ) in one PDCCH, and the terminal device 120 may assume that the scheduling offset value for the PDSCH, PUSCH or AP-CSI-RS scheduled in this PDCCH to be Kₘ.

In some embodiments, the terminal device 120 may be configured with a set of scheduling offset values. For example, the set of scheduling offset values may include N values, where N is an integer and N>1. In some embodiments, a first group of values selected from the set of scheduling offset values may be indicated as valid to the terminal device 120. For example, the first group of values may include M values, where M is an integer and M>=1. For example, a second group of values including the remaining N−M values may be invalid. In some embodiments, the terminal device 120 may only expect to be indicated with one or more of the first group of valid values for scheduling. In some embodiments, the terminal device 120 may be indicated with one or more of the second group of invalid values, and the terminal device 120 may assume that the scheduling mode is switched to the second scheduling mode.

In some embodiments, the terminal device 120 may be configured with a set of scheduling offset values. For example, the set of scheduling offset values may include N values, where N is an integer and N>1. In some embodiments, a first group of values selected from the set of scheduling offset values may be indicated as valid to the terminal device 120. For example, the first group of values may include M values, where M is an integer and M>=1. For example, the remaining N−M values may be invalid. In some embodiments, the remaining N−M values may be further divided into two groups. For example, a second group of values may include L values selected from the remaining N−M values, for example, where L is an integer and L>=1. In addition, a third group of values may include N−M−L values selected from the remaining N−M values. In some embodiments, the terminal device 120 may only expect to be indicated with one or more of the first group of valid values for scheduling. In some embodiments, the terminal device 120 may be indicated with one or more of the second group of invalid values, and the terminal device 120 may assume that the scheduling mode is switched to the second scheduling mode. In some embodiments, the terminal device 120 may be indicated with one or more of the third group of invalid values, and the terminal device 120 may assume that the scheduling mode is switched to the first scheduling mode.

In this way, dynamic switching between the scheduling mode for power saving (that is, the first scheduling mode as described above) and the scheduling mode for quick scheduling (that is, the second scheduling mode as described above) can be enabled. It is to be understood that the above embodiments about the dynamic switching from the first scheduling mode to the second scheduling mode are shown merely for the purpose of illustration, without suggesting any limitation to the present disclosure. Embodiments of the present disclosure are also applicable to switching from the second scheduling mode for quick scheduling to the first scheduling mode for power saving.

FIG. 3 illustrates an example method 300 in accordance with some embodiments of the present disclosure. In some embodiments, for example, the method 300 may be performed at the terminal device 120 as shown in FIG. 1. It is to be understood that the method 300 may include additional blocks not shown and/or may omit some blocks as shown, and the scope of the present disclosure is not limited in this regard.

At block 310, the terminal device 120 receives, in a first scheduling mode, first control information from the network device 110.

At block 320, the terminal device 120 determines whether the first control information includes an indication to switch from the first scheduling mode to a second scheduling mode.

At block 330, in response to the first control information including the indication, the terminal device 120 switches from the first scheduling mode to the second scheduling mode.

In some embodiments, the first scheduling mode indicates that reception of scheduling information and a data communication scheduled by the scheduling information occur in different slots. In some embodiments, the second scheduling mode indicates that the reception of the scheduling information and the data communication scheduled by the scheduling information are able to occur in a same slot.

In some embodiments, the first scheduling mode is associated with a first group of scheduling offset values. In some embodiments, in response to the first control information including a scheduling offset value that is below the minimum one of the first group of scheduling offset values, the terminal device 120 determines that the first control information includes the indication.

In some embodiments, the second scheduling mode is associated with a second group of scheduling offset values. In some embodiments, in response to the first control information including one of the second group of scheduling offset values, the terminal device 120 determines that the first control information includes the indication.

In some embodiments, the terminal device 120 switches, on an occasion to receive second control information from the network device, from the first scheduling mode to the second scheduling mode.

In some embodiments, in response to the first control information including scheduling information for scheduling a data communication, the terminal device 120 disables the data communication scheduled by the scheduling information.

In some embodiments, in response to the first control information including scheduling information for scheduling a data communication, the terminal device 120 determines a scheduling offset value for the first scheduling mode, the scheduling offset value indicating a slot offset between reception of the scheduling information and the data communication scheduled by the scheduling information. Then, the terminal device 120 performs the data communication based on the scheduling offset value.

In some embodiments, the terminal device 120 is configured with a first group of scheduling offset values associated with the first scheduling mode. In some embodiments, the terminal device 120 determines the scheduling offset value from the first group of scheduling offset values.

In some embodiments, in response to the terminal device 120 having switched from the first scheduling mode to the second scheduling mode for a period of time, the terminal device 120 switches from the second scheduling mode back to the first scheduling mode.

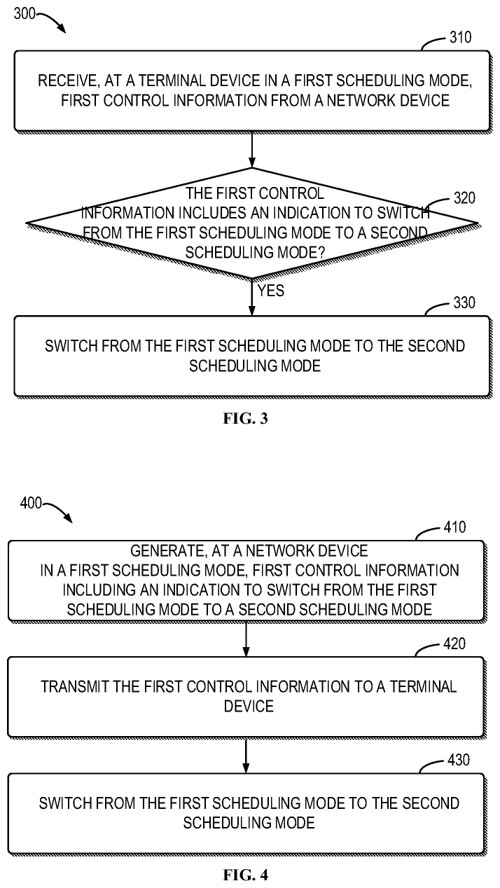

FIG. 4 illustrates an example method 400 in accordance with some embodiments of the present disclosure. In some embodiments, for example, the method 400 may be performed at the network device 110 as shown in FIG. 1. It is to be understood that the method 400 may include additional blocks not shown and/or may omit some blocks as shown, and the scope of the present disclosure is not limited in this regard.

At block 410, the network device 110 generates, in a first scheduling mode, first control information including an indication to switch from the first scheduling mode to a second scheduling mode.

At block 420, the network device 110 transmits the first control information to the terminal device 120.

At block 430, the network device 110 switches from the first scheduling mode to the second scheduling mode.

In some embodiments, the first scheduling mode indicates that transmission of scheduling information and a data communication scheduled by the scheduling information occur in different slots. In some embodiments, the second scheduling mode indicates that the transmission of the scheduling information and the data communication scheduled by the scheduling information are able to occur in a same slot.

In some embodiments, the first scheduling mode is associated with a first group of scheduling offset values. In some embodiments, the network device 110 determines a scheduling offset value that is below the minimum one of the first group of scheduling offset values. The network device 110 further includes, in the control information, the scheduling offset value as the indication.

In some embodiments, the second scheduling mode is associated with a second group of scheduling offset values. In some embodiments, the network device 110 selects a scheduling offset value from the second group of scheduling offset values. The network device 110 further includes, in the control information, the scheduling offset value as the indication.

In some embodiments, the network device 110 switches, on an occasion to transmit second control information to the terminal device, from the first scheduling mode to the second scheduling mode.

In some embodiments, the first control information includes scheduling information for scheduling a data communication. In some embodiments, the network device 110 disables the data communication scheduled by the scheduling information. Alternatively, in some embodiments, the network device 110 determines a scheduling offset value for the first scheduling mode, the scheduling offset value indicating a slot offset between reception of the scheduling information and the data communication scheduled by the scheduling information. Then, the network device 110 performs the data communication based on the scheduling offset value.

In some embodiments, the network device 110 is configured with a first group of scheduling offset values associated with the first scheduling mode. In some embodiments, the network device 110 determines the scheduling offset value from the first group of scheduling offset values.

In some embodiments, in response to the network device 110 having switched from the first scheduling mode to the second scheduling mode for a period of time, the network device 110 switches from the second scheduling mode back to the first scheduling mode.

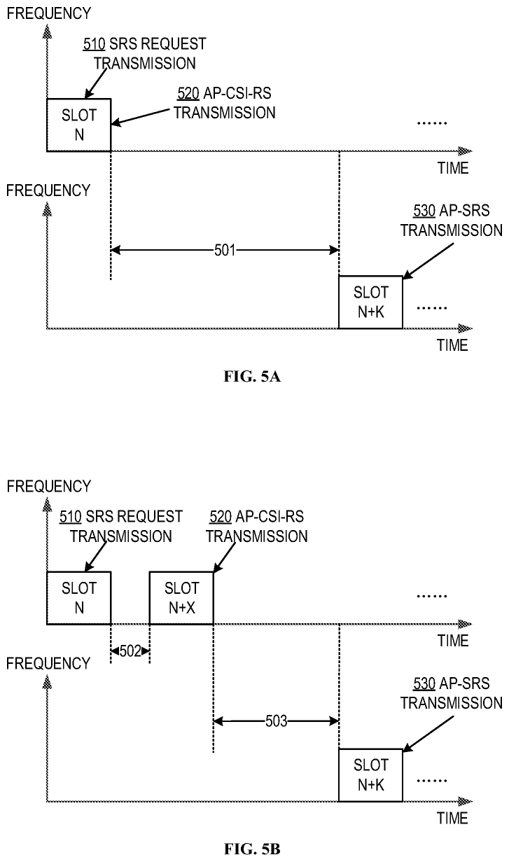

As described above, in traditional solutions, the network device 110 may indicate a downlink measurement RS (such as, an AP-CSI-RS) for the terminal device 120 to determine DL candidate pre-coders for an AP-SRS via DCI. That is, the AP-SRS can be associated with an AP-CSI-RS. The network device 110 can delay transmission of the AP-CSI-RS by several slots than the transmission of the DCI containing a trigger of the AP-SRS, so as to reduce power consumption. However, this may decrease an interval between reception of the AP-CSI-RS and transmission of the AP-SRS at the UE. If the interval is below a threshold (such as, 42 OFDM symbols), the uplink pre-coder for the AP-SRS will not be updated. FIGS. 5A and 5B illustrate example diagrams of AP-CSI-RS and AP-SRS transmission in the traditional solutions.

As shown in FIG. 5A, in some traditional solutions (for example, according to Release 15 of 3GPP specifications), a request for an AP-SRS may be transmitted from the network device 110 to the terminal device 120 in Slot N. For example, the transmission of the request for the SRS is shown as 510 in FIG. 5A. An AP-CSI-RS associated with the SRS may be transmitted from the network device 110 to the terminal device 120 in the same Slot N. For example, the transmission of the AP-CSI-RS is shown as 520 in FIG. 5A. An offset 501 (for example, K slots) between the SRS request transmission 510 and the AP-SRS transmission 530 may be configured via Radio Resource Control (RRC) signaling to the terminal device 120. Therefore, the SRS may be transmitted from the terminal device 120 to the network device 110 in Slot N+K. An offset (that is, the slot offset 501) between the AP-CSI-RS transmission 520 and the AP-SRS transmission 530 should exceed a threshold (such as, 42 OFDM symbols), such that the pre-coder for the AP-SRS transmitted in Slot N+K can be updated based on the AP-CSI-RS received by the terminal device 120.

As shown in FIG. 5B, in some other traditional solutions (for example, according to Release 16 of 3GPP specifications), the AP-CSI-RS transmission 520 may be delayed X slots for power saving than the SRS request transmission 510. For example, in FIG. 5B, the AP-CSI-RS transmission 520 occurs in Slot N+X. An offset (for example, K slots) between the SRS request transmission 510 and the AP-SRS transmission 530 may be configured via Radio Resource Control (RRC) signaling to the terminal device 120. Therefore, the SRS may be transmitted from the terminal device 120 to the network device 110 in Slot N+K. However, since the AP-CSI-RS transmission 520 is delayed X slots, an offset 503 between the AP-CSI-RS transmission 520 and the AP-SRS transmission 530 will be decreased. If the offset 503 is below the threshold (such as, 42 OFDM symbols), the pre-coder for the AP-SRS transmitted in Slot N+K will not be updated based on the AP-CSI-RS received by the terminal device 120.

Example embodiments of the present disclosure provide a solution for AP-CSI-RS and AP-SRS transmission. This solution enables adjusting of AP-SRS transmission in case that the AP-SRS is associated with an AP-CSI-RS for calculating a pre-coder. This solution can ensure that the time interval between the AP-CSI-RS transmission and the AP-SRS transmission exceeds a threshold, such that the pre-coder for the AP-SRS will be updated to the calculated one.

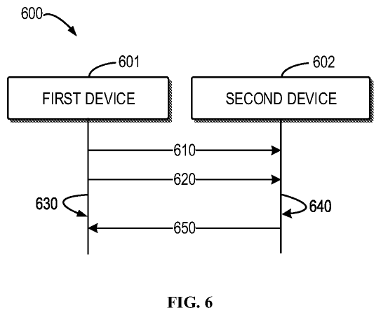

FIG. 6 illustrates an example signaling chart illustrating a process 600 for AP-CSI-RS and AP-SRS transmission in accordance with some embodiments of the present disclosure. It is also to be understood that the process 600 may include additional acts not shown and/or may omit some acts as shown, and the scope of the present disclosure is not limited in this regard.

As shown in FIG. 6, the process 600 may involve a first device 601 and a second device 602. In the following, the network device 110 will be taken as an example of the first device 601 and the terminal device 120 will be taken as an example of the second device 602. However, it is to be understood that this is merely for the purpose of illustration, without suggesting any limitation to the present disclosure. In some embodiments, for example, the first device 601 may be the terminal device 120 in FIG. 1 and the second device 602 may be the network device 110 in FIG. 1.

As shown in FIG. 6, in some embodiments, the first device 601 (such as, the network device 110) may transmit 610 a request for a SRS (such as, an AP-SRS) to the second device 602 in a first slot. For example, the SRS may be associated with a CSI-RS (such as, an AP-CSI-RS) for calculating a pre-coder for the SRS. In some embodiments, the second device 602 may receive the request for the SRS in the first slot.

In some embodiments, the first device 601 may be configured with a first slot offset between transmission of the request and transmission of the CSI-RS. In some embodiments, the first device 601 may transmit 620 the CSI-RS to the second device 602 in a second slot later than the first slot by the first slot offset. In some embodiments, when the first device 601 is a network device and the second device 602 is a terminal device, the first device 601 may configure the first slot offset to the second device 602. In some embodiments, the first slot offset may be configured to the second device 602 via RRC signaling or any other signaling. As such, the second device 602 may receive the CSI-RS associated with the SRS in the second slot which is later than the first slot by the first slot offset.

In some embodiments, the first device 601 may also be configured with a second slot offset between transmission of the request and reception of the SRS. In some embodiments, the first device 601 may determine 630 a third slot for receiving the SRS from the second device 602 based on the first and second slot offsets. In some embodiments, if a difference between the second slot offset and the first slot offset exceed a threshold (such as, 42 OFDM symbols), the first device 601 may determine 630 the third slot such that the third slot is later than the first slot by the second slot offset. Alternatively, in some embodiments, if the difference between the second slot offset and the first slot offset is below the threshold, the first device 601 may determine 630 the third slot such that the third slot is later than the second slot by the second slot offset.

In some embodiments, when the first device 601 is a network device and the second device 602 is a terminal device, the first device 601 may configure the second slot offset to the second device 602. In some embodiments, the second slot offset may be configured to the second device 602 via RRC signaling or any other signaling. As such, the second device 602 may determine 640 a third slot for transmitting the SRS to the first device 601 based on the first and second slot offsets. In some embodiments, if a difference between the second slot offset and the first slot offset exceed a threshold (such as, 42 OFDM symbols), the second device 602 may determine 640 the third slot such that the third slot is later than the first slot by the second slot offset. Alternatively, in some embodiments, if the difference between the second slot offset and the first slot offset is below the threshold, the second device 602 may determine 640 the third slot such that the third slot is later than the second slot by the second slot offset.

As shown in FIG. 6, in some embodiments, the second device 602 may transmit 650 the SRS to the first device 601 based on the determined third slot. In some embodiments, the first device 601 may receive the SRS from the first device 601 based on the determined third slot.

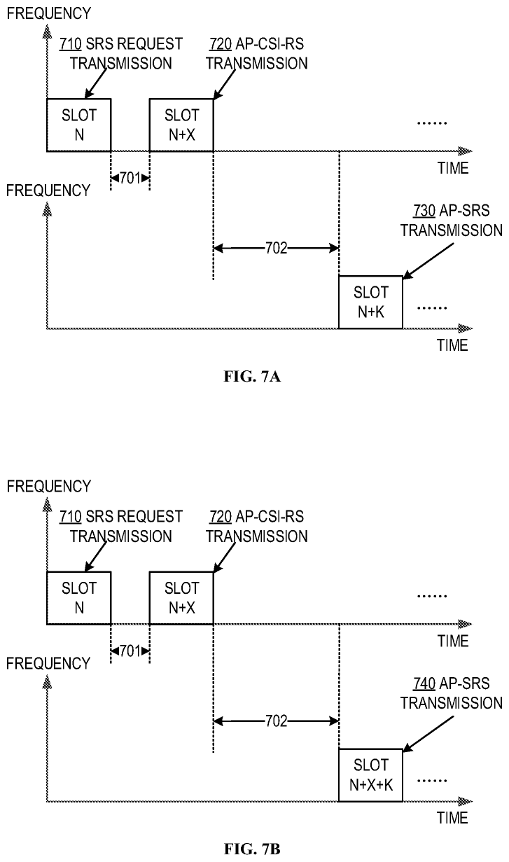

FIGS. 7A and 7B illustrate example diagrams of AP-CSI-RS and AP-SRS transmission in accordance with some embodiments of the present disclosure. As shown in FIGS. 7A and 7B, a request for an AP-SRS may be transmitted from the first device 601 to the second device 602 in Slot N (that is, the first slot as described above with reference to FIG. 6). For example, in FIGS. 7A and 7B, the transmission of the SRS request is shown as 710. The AP-CSI-RS associated with the AP-SRS may be transmitted from the first device 601 to the second device 602 in Slot N+X (that is, the second slot as described above with reference to FIG. 6), which is later than Slot N (that is, the first slot) by a first slot offset 701. For example, in FIGS. 7A and 7B, the transmission of the AP-CSI-RS in Slot N+X is shown as 720. A second slot offset (for example, K slots) between transmission of the SRS request and reception of the AP-SRS may be configured to the first device 601. The second slot offset between reception of the SRS request and transmission of the AP-SRS may also be configured to the second device 602. If a time interval 702 between reception of the AP-CSI-RS and the transmission of the AP-SRS still exceeds the threshold (such as, 42 OFDM symbols), the second device 602 may following the configured second slot offset (that is, K slots) and transmit the AP-SRS in Slot N+K. For example, in FIG. 7A, the transmission of the AP-SRS in Slot N+K is shown as 730. However, if the time interval 702 between reception of the AP-CSI-RS and the transmission of the AP-SRS is below the threshold due to the delay of the AP-CSI-RS transmission, the second device 602 may also delay the transmission of the AP-SRS by X slots. For example, the transmission of the AP-SRS may occur in Slot N+X+K, which is shown as 740 in FIG. 7B.

In some embodiments, the second device 602 may be the terminal device 120. For example, the terminal device 120 may be configured with an AP-SRS trigger offset value K (that is, the second slot offset as described above) via RRC signaling, where K is a non-negative integer. The terminal device 120 may be also configured with an AP-CSI-RS associated with the AP-SRS. In some embodiments, the terminal device 120 may receive DCI in slot N, the DCI including a SRS request field for triggering AP-SRS transmission. The terminal device 120 may receive an associated AP-CSI-RS in slot N+X, where X is an integer and X>=1. In some embodiments, the terminal device 120 may transmit the corresponding AP-SRS in Slot N+X+K. In some embodiments, if the gap from the last symbol of reception of the aperiodic Non-Zero Power (NZP) CSI-RS resource and the first symbol of the aperiodic SRS resource in Slot N+K exceeds or equals to 42 OFDM symbols, the terminal device 120 may transmit the corresponding AP-SRS in Slot N+K. Alternatively, in some embodiments, if the gap from the last symbol of the reception of the aperiodic NZP CSI-RS resource and the first symbol of the aperiodic SRS resource in slot N+K is below 42 OFDM symbols, the terminal device 120 may transmit the corresponding AP-SRS in Slot N+K+X. Alternatively, in some embodiments, if the gap from the last symbol of the aperiodic NZP CSI-RS resource in Slot N+X and the first symbol of the aperiodic SRS resource in Slot N+K is below 42 OFDM symbols, the terminal device 120 may receive the associated AP-CSI-RS in Slot N, and transmit the corresponding AP-SRS in Slot N+K. That is, in this case the terminal device 120 may not delay the transmission of the AP-CSI-RS for power saving.

In this way, embodiments of the present disclosure enable adjusting of AP-SRS transmission in case that the AP-SRS is associated with an AP-CSI-RS for calculating a pre-coder. Embodiments of the present disclosure can ensure that the time interval between the AP-CSI-RS transmission and the AP-SRS transmission exceeds a threshold, such that the pre-coder for the AP-SRS will be updated to the calculated one.

FIG. 8 illustrates an example method 800 in accordance with some embodiments of the present disclosure. In some embodiments, for example, the method 800 may be performed at the first device 601 as shown in FIG. 6. It is to be understood that the method 800 may include additional blocks not shown and/or may omit some blocks as shown, and the scope of the present disclosure is not limited in this regard.

At block 810, the first device 601 transmits a request for a SRS to the second device 602 in a first slot. The SRS is associated with a CSI-RS.

At block 820, in response to the first device 601 being configured with a first slot offset between transmission of the request and transmission of the CSI-RS, the first device 601 transmits the CSI-RS to the second device 602 in a second slot later than the first slot by the first slot offset.

At block 830, in response to the first device 601 being configured with a second slot offset between transmission of the request and reception of the SRS, the first device 601 determines a third slot for receiving the SRS from the second device 602 based on the first and second slot offsets.

At block 840, the first device 601 receives the SRS from the second device 602 in the third slot.

In some embodiments, the first device 601 determines whether a difference between the second slot offset and the first slot offset exceeds a threshold. In response to the difference between the second slot offset and the first slot offset exceeding the threshold, the first device 601 determines the third slot such that the third slot is later than the first slot by the second slot offset.

In some embodiments, in response to the difference between the second slot offset and the first slot offset being below the threshold, the first device 601 determines the third slot such that the third slot is later than the second slot by the second slot offset.

In some embodiments, the first device 601 is a network device and the second device 602 is a terminal device.

In some embodiments, the first device 601 transmits at least one configuration to the second device 602. The at least one configuration configuring the first slot offset and/or the second slot offset to the second device 602.

In some embodiments, the first device 601 transmits the at least one configuration via Radio Resource Control (RRC) signaling.

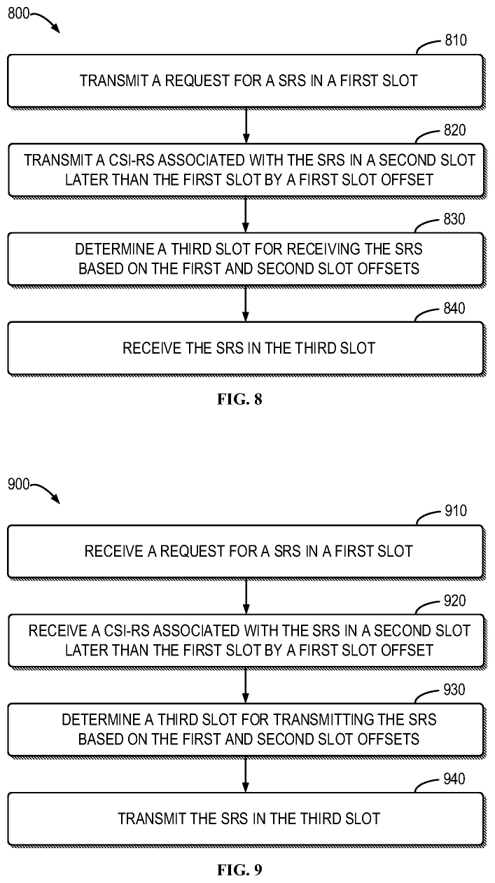

FIG. 9 illustrates an example method 900 in accordance with some embodiments of the present disclosure. In some embodiments, for example, the method 900 may be performed at the second device 602 as shown in FIG. 1. It is to be understood that the method 900 may include additional blocks not shown and/or may omit some blocks as shown, and the scope of the present disclosure is not limited in this regard.

At block 910, the second device 602 receives a request for a SRS from the first device 601 in a first slot. The SRS is associated with a CSI-RS.

At block 920, in response to the second device 602 being configured with a first slot offset between reception of the request and reception of the CSI-RS, the second device 602 receives the CSI-RS from the first device 601 in a second slot later than the first slot by the first slot offset.

At block 930, in response to the second device 602 being configured with a second slot offset between reception of the request and transmission of the SRS, the second device 602 determines a third slot for transmitting the SRS to the first device 601 based on the first and second slot offsets.

At block 940, the second device 602 transmits the SRS to the first device 601 in the third slot.

In some embodiments, the terminal device 120 determines whether a difference between the second slot offset and the first slot offset exceeds a threshold. In response to the difference between the second slot offset and the first slot offset exceeding the threshold, the terminal device 120 determines the third slot such that the third slot is later than the first slot by the second slot offset.

In some embodiments, in response to the difference between the second slot offset and the first slot offset being below the threshold, the terminal device 120 determines the third slot such that the third slot is later than the second slot by the second slot offset.

In some embodiments, the first device 601 is a network device and the second device 602 is a terminal device.

In some embodiments, the terminal device 120 receives at least one configuration to the first device 601. The at least one configuration configuring the first slot offset and/or the second slot offset to the terminal device 120.

In some embodiments, the terminal device 120 receives the at least one configuration via Radio Resource Control (RRC) signaling.

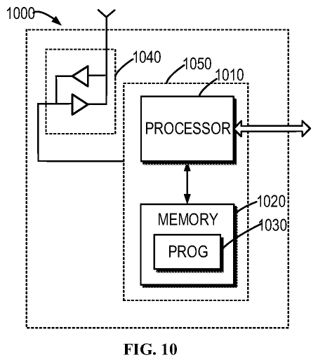

FIG. 10 is a simplified block diagram of a device 1000 that is suitable for implementing embodiments of the present disclosure. The device 1000 can be considered as a further example implementation of the network device 110 or the terminal device 120 as shown in FIG. 1. Accordingly, the device 1000 can be implemented at or as at least a part of the network device 110 or the terminal device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones.

The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-4, 6 and 8-9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-38. (canceled)

39. A method of communication, comprising:
receiving, at a terminal device in a first scheduling mode, first control information from a network device;
determining whether the first control information includes an indication to switch from the first scheduling mode to a second scheduling mode; and
in response to the first control information including the indication, switching from the first scheduling mode to the second scheduling mode.

40. The method of claim 39, wherein the first scheduling mode indicates that reception of scheduling information and a data communication scheduled by the scheduling information occur in different slots, and wherein the second scheduling mode indicates that the reception of the scheduling information and the data communication scheduled by the scheduling information are able to occur in a same slot.

41. The method of claim 40, wherein the first scheduling mode is associated with a first group of scheduling offset values, and wherein determining whether the first control information includes the indication comprises:
in response to the first control information including a scheduling offset value that is below the minimum one of the first group of scheduling offset values, determining that the first control information includes the indication.

42. The method of claim 39, wherein the second scheduling mode is associated with a second group of scheduling offset values, and wherein determining whether the first control information includes the indication comprises:
in response to the first control information including one of the second group of scheduling offset values, determining that the first control information includes the indication.

43. The method of claim 39, wherein switching from the first scheduling mode to the second scheduling mode comprises:
switching, on an occasion to receive second control information from the network device, from the first scheduling mode to the second scheduling mode.

44. The method of claim 39, further comprising:
in response to the first control information including scheduling information for scheduling a data communication, disabling the data communication scheduled by the scheduling information.

45. The method of claim 39, further comprising:
in response to the first control information including scheduling information for scheduling a data communication, determining a scheduling offset value for the first scheduling mode, the scheduling offset value indicating a slot offset between reception of the scheduling information and the data communication scheduled by the scheduling information; and
performing the data communication based on the scheduling offset value.

46. The method of claim 45, wherein the terminal device is configured with a first group of scheduling offset values associated with the first scheduling mode, and wherein determining the scheduling offset value comprises:
determining the scheduling offset value from the first group of scheduling offset values.

47. A method of communication, comprising:
generating, at a network device in a first scheduling mode, first control information including an indication to switch from the first scheduling mode to a second scheduling mode;
transmitting the first control information to a terminal device; and
switching from the first scheduling mode to the second scheduling mode.

48. The method of claim 47, wherein the first scheduling mode indicates that transmission of scheduling information and a data communication scheduled by the scheduling information occur in different slots, and wherein the second scheduling mode indicates that the transmission of the scheduling information and the data communication scheduled by the scheduling information are able to occur in a same slot.

49. The method of claim 48, wherein the first scheduling mode is associated with a first group of scheduling offset values, and wherein generating the first control information including the indication comprises:
determining a scheduling offset value that is below the minimum one of the first group of scheduling offset values; and
including, in the control information, the scheduling offset value as the indication.

50. The method of claim 47, wherein the second scheduling mode is associated with a second group of scheduling offset values, and wherein generating the first control information including the indication comprises:
selecting a scheduling offset value from the second group of scheduling offset values; and
including, in the control information, the scheduling offset value as the indication.

51. The method of claim 47, wherein switching from the first scheduling mode to the second scheduling mode comprises:
switching, on an occasion to transmit second control information to the terminal device, from the first scheduling mode to the second scheduling mode.

52. The method of claim 47, wherein the first control information includes scheduling information for scheduling a data communication, and wherein the method further comprises:
disabling the data communication scheduled by the scheduling information.

53. The method of claim 47, wherein the first control information includes scheduling information for scheduling a data communication, and wherein the method further comprises:
determining a scheduling offset value for the first scheduling mode, the scheduling offset value indicating a slot offset between reception of the scheduling information and the data communication scheduled by the scheduling information; and
performing the data communication based on the scheduling offset value.

54. The method of claim 47, further comprising:
in response to the network device having switched from the first scheduling mode to the second scheduling mode for a period of time, switching from the second scheduling mode back to the first scheduling mode.

55. A method of communication, comprising:
transmitting, from a first device, a request for a Sounding Reference Signal (SRS) to a second device in a first slot, the SRS being associated with a Channel State Information-Reference Signal (CSI-RS);
in response to the first device being configured with a first slot offset between transmission of the request and transmission of the CSI-RS, transmitting the CSI-RS to the second device in a second slot later than the first slot by the first slot offset;
in response to the first device being configured with a second slot offset between transmission of the request and reception of the SRS, determining a third slot for receiving the SRS from the second device based on the first and second slot offsets; and
receiving the SRS from the second device in the third slot.

56. The method of claim 55, wherein determining the third slot comprises:
determining whether a difference between the second slot offset and the first slot offset exceeds a threshold;
in response to the difference between the second slot offset and the first slot offset exceeding the threshold, determining the third slot such that the third slot is later than the first slot by the second slot offset.

57. The method of claim 56, further comprising:
in response to the difference between the second slot offset and the first slot offset being below the threshold, determining the third slot such that the third slot is later than the second slot by the second slot offset.

58. The method of claim 56, further comprising:
transmitting at least one configuration to the second device, the at least one configuration configuring the first slot offset and/or the second slot offset to the second device.
